(19) United States
(12) Patent Application Publication
(10) Pub. No.: US 2011/0175959 A1
(43) Pub. Date: Jul. 21, 2011

(54) THERMAL FLUID-EJECTION DEVICE DIE

(76) Inventors: Andrew L. Van Brocklin, Corvallis, OR (US); Chris Bakker, Corvallis, OR (US); Mark Hunter, Portland, OR (US); Eric Martin, Corvallis, OR (US)

(21) Appl. No.: 13/119,500

(22) PCT Filed: Oct. 31, 2008
(86) PCT No.: PCT/US08/82112

§ 371 Date: Mar. 17, 2011

(51) Int. Cl. B41J 29/38; B41J 2/05

(52) U.S. Cl. 347/14; 347/61

(57) ABSTRACT

A die for a thermal drop-on-demand fluid-ejection device includes thermal firing resistors, low-side switches, and high-side switches. The thermal firing resistors are organized over resistor groups such that each thermal firing resistor is located within only one of the resistor groups. The resistor groups are lesser in number than the thermal firing resistors. Each thermal firing resistor has a first end and a second end. The low-side switches are equal in number to the thermal firing resistors. Each low-side switch connects the second end of a corresponding thermal firing resistor to a low voltage. The high-side switches are equal in number to the resistor groups. Each high-side switch connects the first ends of the thermal firing resistors of a corresponding resistor group to power providing a voltage greater than the low voltage.

### BACKGROUND

A thermal drop-on-demand fluid-ejection device causes a fluid droplet to be ejected from a fluid-ejection nozzle by passing current through a corresponding thermal firing resistor. The current passing through the resistor causes the resistor to increase in temperature, which in turn increases the temperature of the fluid adjacent to the resistor. As a result of the fluid increasing in temperature, a fluid droplet is ejected from the fluid-ejection nozzle.

A dielectric or other material insulates the resistor from the fluid. If the resistor is continually connected to power, even if the resistor is not continually connected to ground such that current does not continually pass through the resistor, any rupture or manufacturing defect within the dielectric can cause rapid corrosion. This corrosion can progress to the die and/or printhead of which the resistor is a part, causing the entire die and/or printhead to fail.

### BRIEF DESCRIPTION OF THE DRAWINGS

FIG. 1 is a diagram of a thermal drop-on-demand fluid-ejection device die, according to an embodiment of the disclosure.

FIG. 2 is a diagram of a portion of the die of FIG. 1, according to an embodiment of the disclosure.

FIG. 3 is a flowchart of a method for ejecting a fluid droplet using the die of FIGS. 1 and 2, according to an embodiment of the disclosure.

FIG. 4 is a diagram of a representative thermal drop-on-demand fluid-ejection device, according to an embodiment of the disclosure.

FIG. 5 is a diagram depicting a number of dies organized in a stationary page-wide array configuration, according to an embodiment of the disclosure.

FIG. 6 is a diagram of a die situated in a scanning printhead configuration, according to an embodiment of the disclosure.

### DETAILED DESCRIPTION

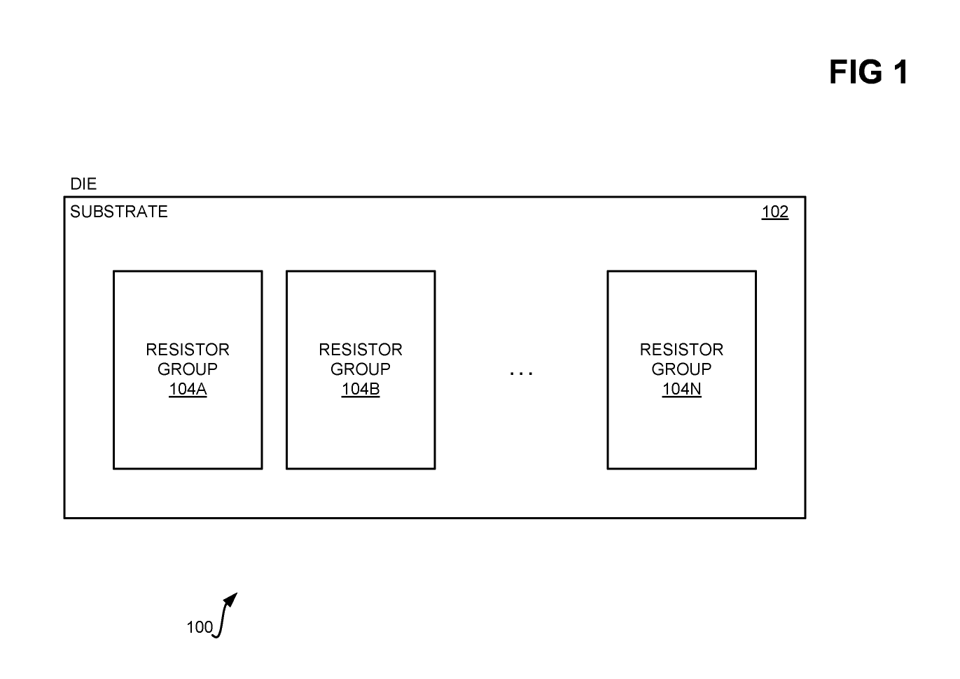

FIG. 1 shows a thermal drop-on-demand fluid-ejection device die 100, according to an embodiment of the disclosure. That is, the die 100 is for a thermal drop-on-demand fluid-ejection device, such as an inkjet-printing device. The die 100 is said to include a substrate 102. The terminology substrate is used herein in a broad and all-encompassing sense, in that various devices and/or components are said to be fabricated or formed within (i.e., on) the substrate 102 of the die 100. The substrate 102 of the die 100 includes a number of resistor groups 104A, 104B, . . . 104N, collectively referred to as the resistor groups 104. The resistor groups 104 may also be referred to as primitives. In one embodiment, there may be forty-four resistor groups 104 on the die 100.

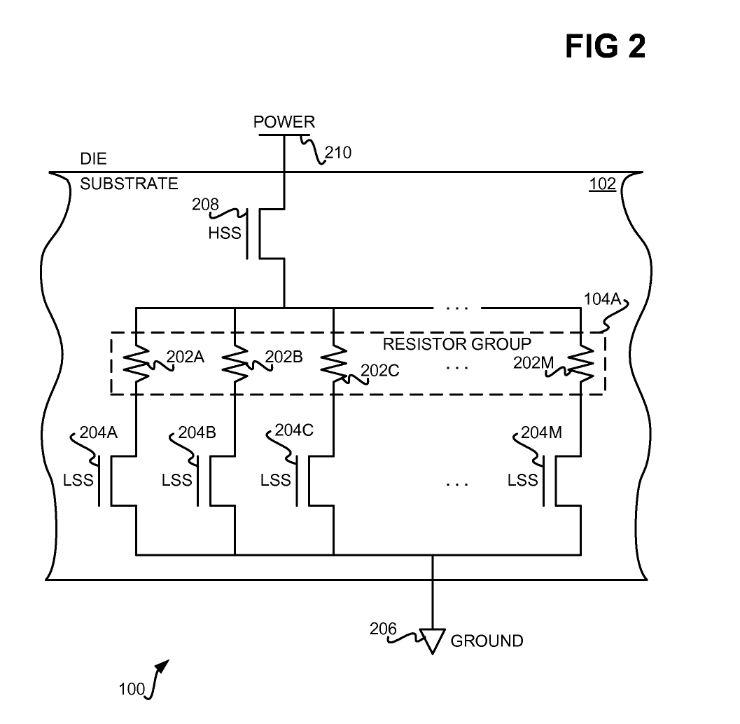

FIG. 2 shows a portion of the thermal drop-on-demand fluid-ejection device die 100 in more detail, according to an embodiment of the disclosure. The resistor group 104A is exemplarily depicted in FIG. 2 as representative of all the resistor groups 104. The resistor group 104A includes a number of thermal firing resistors 202A, 202B, 202C, . . . , 202M, collectively referred to as the thermal firing resistors 202. The thermal firing resistors 202 are formed within (i.e., on) the substrate 102 of the die 100. When current is caused to pass through a given thermal firing resistor, this resistor causes a fluid droplet to be thermally ejected, on a drop-on-demand basis, from a corresponding fluid-ejection nozzle of the fluid-ejection device in question.

Current is caused to pass through the thermal firing resistors 202 as follows. First, there are low-side switches 204A, 204B, 204C, . . . , 204M, collectively referred to as the low-side switches 204, corresponding to the thermal firing resistors 202. The low-side switches 204 may be transistors, or other types of switches. Thus, for each thermal firing resistor there is a corresponding low-side switch. Each low-side switch connects one end of a corresponding thermal firing resistor to a low voltage 206. Therefore, if a given thermal firing resistor is to have current passed therethrough, the corresponding low-side switch is closed (i.e., turned on).

Second, there is one high-side switch 208 for all the thermal firing resistors 202 within the resistor group 104A. The high-side switch 208 may be a transistor, or another type of switch. The high-side switch 208 connects the other end of each of the thermal firing resistors 202 to power 210, which may be a voltage source between fifteen and thirty volts. Therefore, if a given thermal firing resistor is to have current passed therethrough, the high-side switch for the resistor group in which the given thermal firing resistor is located is closed (i.e., turned on), in addition to the low-side switch corresponding to this resistor being closed (i.e., turned on). Closing these two switches causes current to flow within the resistor to eject a fluid droplet from a fluid-ejection nozzle corresponding to the thermal firing resistor in question. Except when a given thermal firing resistor is to be fired, all the low-side and high-side switches remain open (i.e., turned off).

The low voltage 206 to which the low-side switches 204 are connected is a low voltage in that the voltage 206 is less than the voltage provided by power 210. Stated another way, power 210 provides a voltage greater than the low voltage 206. In one embodiment, as is specifically depicted in the figures, the low voltage 206 is ground. In another embodiment, the low voltage 206 itself is a voltage source, but provides a voltage that is less than the voltage provided by power 210.

In one embodiment, there may be eight or twelve thermal firing resistors within each resistor group. Whereas the number of low-side switches is equal in number to the thermal firing resistors—since there is a low-side switch for each resistor—the number of high-side switches is equal in number to the resistor groups 104. This is because there is a high-side switch for each resistor group. It is noted that each resistor is located within only one of the resistor groups 104, and that the number of resistor groups 104 is less than the number of thermal firing resistors.

Embodiments of the disclosure are advantageous as follows. First, assume the alternative scenario in which there is a low-side switch for each thermal firing resistor, but there is no high-side switch. That is, the top ends of the thermal firing resistors are always connected to power 210, but the bottom ends of the resistors are connected to the low voltage 206 through their respective low-side switches. As such, to cause current to flow through a given thermal firing resistor, the low-side switch for this resistor is closed (i.e., turned on).

However, this alternative scenario is disadvantageous, because power 210 is always connected to the thermal firing resistors at their top ends. As a result, if the dielectric or other material separating a given thermal firing resistor from the fluid has a manufacturing defect or suffers a rupture, current will continuously flow through the resistor to the fluid, which can act as a ground or another low voltage less than the voltage provided by power 210. This continuous current flow can cause corrosion progressively throughout the die 100 and the thermal drop-on-demand fluid-ejection printhead of which the die 100 is a part, ultimately causing the die entire 100 and/or printhead to fail.

Second, assume a different alternative scenario in which there is a high-side switch for each thermal firing resistor, but there is no low-side switch. That is, the bottom ends of the thermal firing resistors are always connected to the low voltage 206, but the top ends of the resistors are connected to power 210 through their respective high-side switches. As such, to cause current to flow through a given thermal firing resistor, the high-side switch for this resistor is closed (i.e., turned on).

This alternative scenario is advantageous as compared to the previous alternative scenario described, because power 210 is not continuously connected to the thermal firing resistors. As a result, if the dielectric or other material separating a given thermal firing resistor from fluid has a manufacturing defect or suffers a rupture, current will not continuously flow through the resistor to the fluid, because power 210 is not continuously connected to the resistor. As such, progressive corrosion throughout the die 100 and the thermal drop-on-demand fluid-ejection printhead of which the die 100 is a part is prevented, at least substantially preventing failure of the entire die 100 and/or printhead.

However, this alternative scenario itself is disadvantageous. This is because high-side switches, and their related driving circuitry, can take up significant space on the die 100. The larger the die 100, however, the more expensive it is to manufacture the die 100. Stated another way, space on the die 100 is at a premium, and it can be disadvantageous to relegate so much space on the die 100 to individual high-side switches for the thermal firing resistors.

To overcome this issue, one trend has been to still have one high-side switch per thermal firing resistor, but to relegate the high-side switches off-die, so that they are not formed within (i.e., on) the substrate 102 of the die 100. This approach solves the problem that high-side switches take up too much space on the die 100, since the high-side switches are no longer on the die 100. However, this approach introduces another problem, which is that complicated interconnects that have to be added to individually connect each high-side switch to a corresponding thermal firing resistor. As such, the end result is that undue costs and complications are still added.

Therefore, the inventors have inventively determined that keeping a low-side switch for each thermal firing resistor on the die 100, as in the first alternative scenario described above, while also adding a high-side switch for a number of thermal firing resistors (i.e., for each of the resistor groups 104) solves all of the problems noted above. For example, consider the situation in which there are 528 thermal firing resistors. One embodiment organizes these 528 thermal firing resistors over forty-four resistor groups 104, with twelve resistors per resistor group.

In this embodiment, then, there are just forty-four high-side switches—one for each resistor group—instead of 528 high-side switches as in the second alternative scenario described above. Therefore, the amount of space on the die 100 dedicated to high-side switches is reduced considerably, by nearly 92% (i.e.,

$$\frac{528 - 44}{528} ) .$$

As such, the advantage of the second alternative scenario—having the top ends of the thermal firing resistors connected to power 210 through high-side switches so that the resistors are not continuously connected power 210—is maintained. However, the disadvantage of the second alternative scenario—the amount of space on the die 100 taken up by the high-side switches—is significantly reduced.

A low-side switch is still maintained for each thermal firing resistor in this embodiment because the thermal firing resistors have to be able to be individually fired so that fluid droplets can be ejected from corresponding fluid-ejection nozzles on an individual basis. However, low-side switches and their corresponding driving circuitry do not take up nearly as much space on the die 100 as high-side switches do, at least in part because they are not directly connected to power 210 as the high-side switches are. As such, keeping a low-side switch for each thermal firing resistor is not as much as an issue as would be initially suspected.

Therefore, the inventors have developed an innovative solution to a vexing problem, by adding high-side switches to the die 100 while unintuitively in a non-obvious manner not correspondingly removing any of the low-side switches from the die 100. Alternative solutions, such as replacing existing low-side switches with high-side switches that are either on-die or off-die, are disadvantageous by comparison. The insight of adding an on-die high-side switch for each group of thermal firing resistors, instead of adding a high-side switch for each individual resistor, is advantageous. Because the thermal firing resistors still have to be able to be fired individually, the low-side switches are not removed.

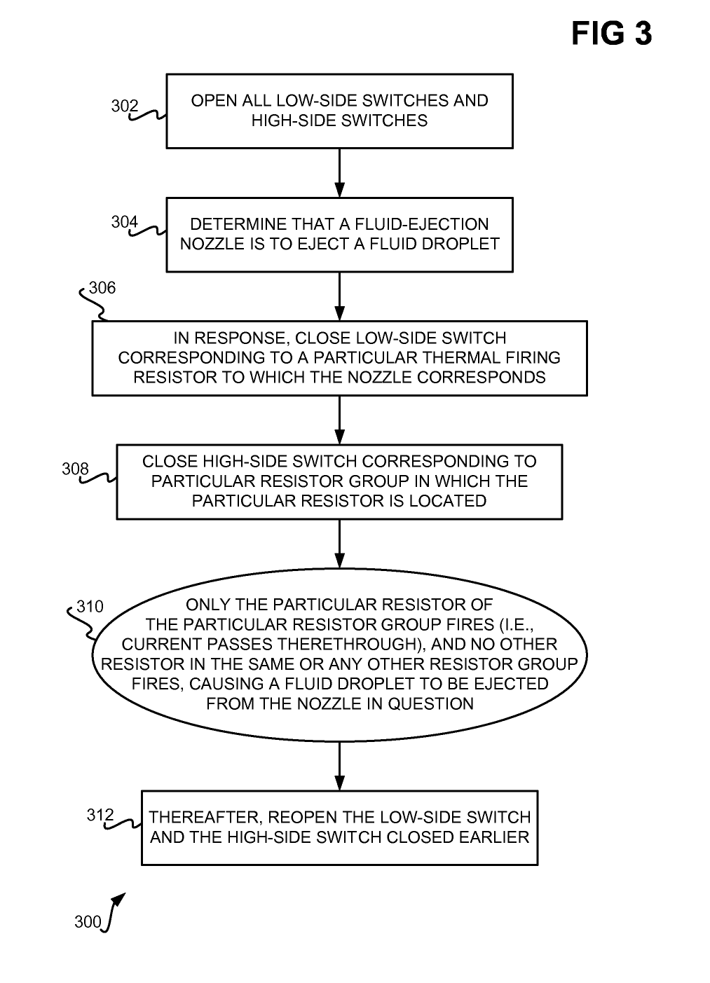

FIG. 3 shows a method 300 for causing a fluid droplet to be ejected from a fluid-ejection nozzle using the die 100, according to an embodiment of the disclosure. For exemplary purposes, it is presumed that the fluid-ejection nozzle corresponding to the thermal firing resistor 202A of the resistor group 104A is to eject a fluid droplet. Initially all the low-side switches and the high-side switches on the die 100 are opened (i.e., turned off) (302).

Upon determining that the fluid-ejection nozzle in question is to eject a fluid droplet (304), the method 300 performs the following in response. The low-side switch 204A corresponding to the thermal firing resistor 202A to which the fluid-ejection nozzle itself corresponds is closed (i.e., turned on) (306). Doing so connects the thermal firing resistor 202A to the low voltage 206. The high-side switch 208 corresponding to the resistor group 104A in which the thermal firing resistor 202A is located is also closed (i.e., turned on) (308). Doing so connects the thermal firing resistor 202A to power 210. It is noted that parts 306 and 308 may be performed in any order, all of which are encompassed by the appending claims. For example, part 306 may be performed prior to part 308, or part 308 may be performed prior to part 306. Additionally, parts 306 and 308 may be performed at least substantially simultaneously.

As a result, only the thermal firing resistor 202A of the resistor group 104A fires (i.e., has current passing therethrough), which causes only the fluid-ejection nozzle corresponding to the resistor 202A to eject a fluid droplet (310). The other thermal firing resistors 202 within the resistor group 104A do not fire, because while they are connected to power 210 as a result of the high-side switch 208 being closed, their corresponding low-side switches 204 remain open, such that the resistors are not connected to ground or to a low voltage that is less than the voltage provided by power 210. The thermal firing resistors of all the other resistor groups 104 also do not fire, because all their high-side and low-side switches remain open. Once the thermal firing resistor 202A has fired, the low-side switch 204A and the high-side switch 208 are reopened as before (312). The switches 204A and 208 may be reopened in any order as well. For example, the switch 204A may be reopened before the switch 208, the switch 208 may be reopened before the switch 204A, or the switches 204A and 208 may be reopened at least substantially simultaneously.

In one embodiment, the low-side switch 204A is kept closed for a period of time after the high-side switch 208 is opened and before the switch 204A is opened, to ensure that any remaining charge is at least substantially completely discharged. Doing this ensures that there is no charge remaining on the resistor 202A that may otherwise be discharged via another route resulting from manufacturing defects between the resistor 202A and the fluid, for instance. As such, ensuring that no charge remains on the resistor 202A reduces the potential that such manufacturing defects may cause or accelerate failure. In another embodiment, a weak pull down on the network of the low-side switches 204A can instead be performed to at least substantially completely discharge any remaining charge once the high-side switch 208 has been opened.

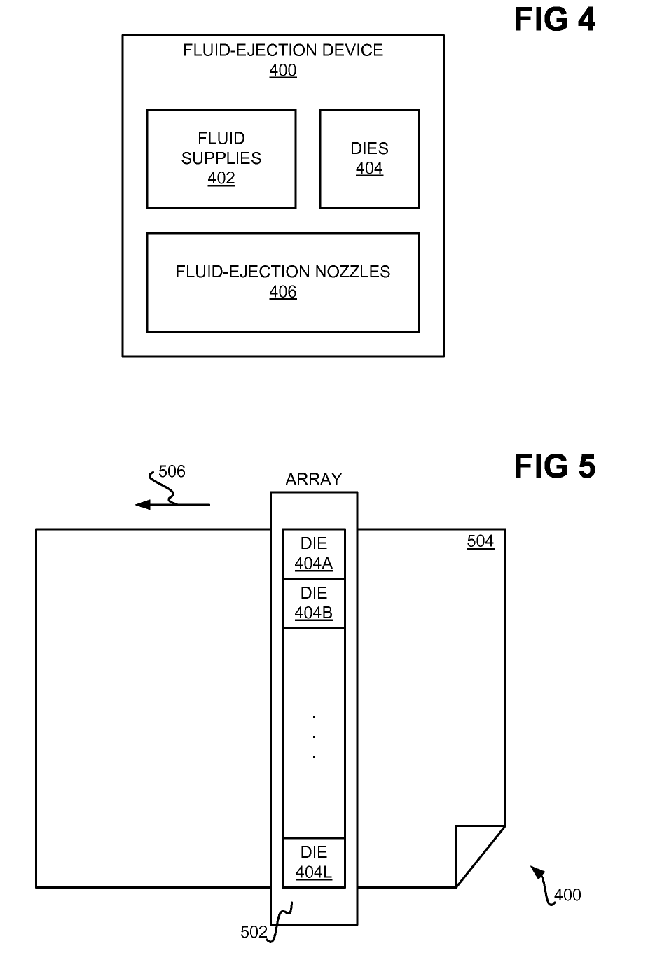

FIG. 4 shows a rudimentary thermal drop-on-demand fluid-ejection device 400, according to an embodiment of the disclosure. The fluid-ejection device 400 is shown in FIG. 4 as including one or more fluid supplies 402, one or more dies 404, and one or more fluid-ejection nozzles 406. The fluid-ejection device 400 can and typically does include other components, in addition and/or in lieu of the fluid supplies 402, the dies 404, and the fluid-ejection nozzles 406.

The fluid-ejection device 400 may be an inkjet-printing device, which is a device, such as a printer, that ejects ink onto media, such as paper, to form images, which can include text, on the media. The fluid-ejection device 400 is more generally a fluid-jet precision-dispensing device that precisely dispenses fluid, such as ink. The fluid-ejection device 100 may eject pigment-based ink, dye-based ink, another type of ink, or another type of fluid. Embodiments of the present disclosure can thus pertain to any type of fluid-jet precision-dispensing device that dispenses a substantially liquid fluid.

A fluid-jet precision-dispensing device is therefore a drop-on-demand device in which printing, or dispensing, of the substantially liquid fluid in question is achieved by precisely printing or dispensing in accurately specified locations, with or without making a particular image on that which is being printed or dispensed on. As such, a fluid-jet precision-dispensing device is in comparison to a continuous precision-dispensing device, in which a substantially liquid fluid is continuously dispensed therefrom. An example of a continuous precision-dispensing device is a continuous inkjet-printing device.

The fluid-jet precision-dispensing device precisely prints or dispenses a substantially liquid fluid in that the latter is not substantially or primarily composed of gases such as air. Examples of such substantially liquid fluids include inks in the case of inkjet-printing devices. Other examples of substantially liquid fluids include drugs, cellular products, organisms, fuel, and so on, which are not substantially or primarily composed of gases such as air and other types of gases, as can be appreciated by those of ordinary skill within the art.

The fluid supplies 402 include the fluid that is ejected by the fluid-ejection device 402. The dies 404 can each be implemented as the die 100 that has been described. The fluid-ejection nozzles 406 are typically part of the dies 404. The fluid-ejection nozzles 406 are particularly the outlets or orifices through which fluid droplets are ejected from the fluid supplies 402 by the fluid-ejection device 400, using the dies 404, as has been described above in particular relation to the die 100.

FIG. 5 shows how the dies 404 can be immovably positioned as a page-wide array 502 laterally in relation to the width of a media sheet 504, according to an embodiment of the disclosure. The dies 404 include dies 404A, 404B, . . . , 404L. The media sheet 504 has a width and a length, where the width is shorter than the length. The axis of the width is referred to by the term lateral or latitudinal, whereas the axis of the length is referred to by the term longitudinal.

The array 502 of the dies 404 is thus positioned, in a stationary manner, laterally across the width of the media sheet 504. The media sheet 504 is caused to advance longitudinally through the fluid-ejection device 400, as indicated by the arrow 506. As the media sheet 504 advances longitudinally, the dies 404 within the array 502 eject fluid onto the media sheet 504. Because the array 502 spans the media sheet 504 laterally from edge to edge and because the media sheet 504 advances longitudinally, the dies 404 can remain stationary and immovable and still be able to eject fluid onto the entirety of the media sheet 504.

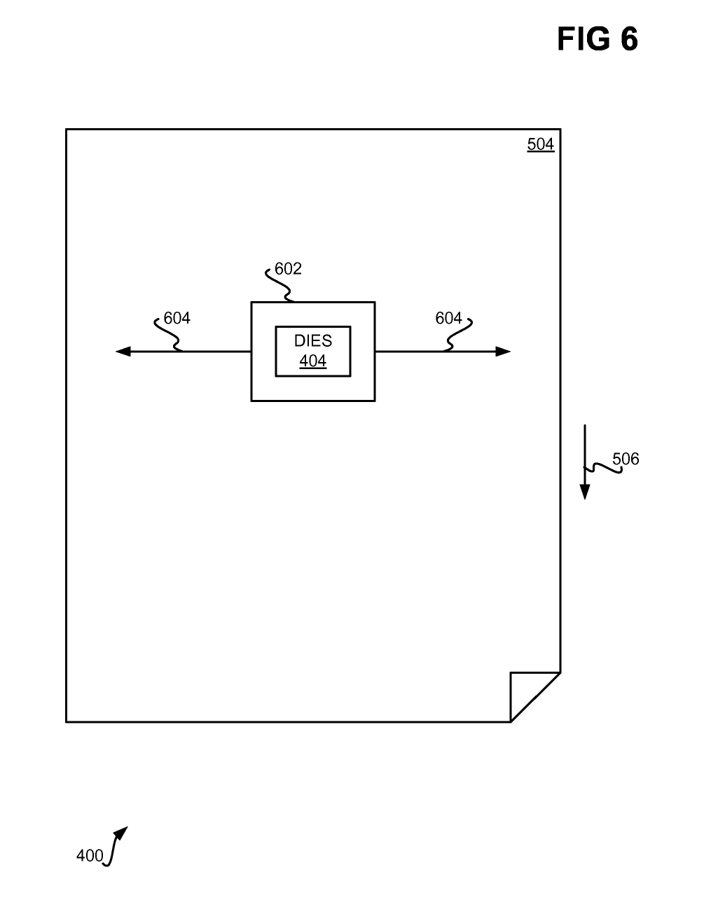

FIG. 6 shows how the dies 404 can be laterally movably positioned in relation to the width of the media sheet 504, according to an embodiment of the disclosure. The dies 404 may include one or more dies. The dies 404 are disposed on a scanning printhead 602 that is able to move laterally in relation to the width of the media sheet 504, as indicated by the arrows 604. By comparison, the media sheet 504 advances longitudinally through the fluid-ejection device 400, as indicated by the arrow 506.

The media sheet 504 is thus caused to longitudinally advance to a number of different longitudinal swaths over its length. At each swath, the scanning printhead 602 moves, or scans, laterally, as indicated by the arrows 604. As the printhead 602 moves laterally, the dies 404 can eject fluid onto the current swath of the media sheet 504. This process is then repeated, so that fluid can be ejected onto the entirety of the media sheet 504.

We claim:

1. A die for a thermal drop-on-demand fluid-ejection device, the die comprising:
a substrate;
a plurality of thermal firing resistors formed on the substrate, the thermal firing resistors organized over a plurality of resistor groups such that each thermal firing resistor is located within only one of the resistor groups, the resistor groups lesser in number than the thermal firing resistors, each thermal firing resistor having a first end and a second end;
a plurality of low-side switches formed within the substrate and equal in number to the thermal firing resistors, each low-side switch connecting the second end of a corresponding thermal firing resistor to a low voltage; and,
a plurality of high-side switches formed on the substrate and equal in number to the resistor groups, each high-side switch connecting the first ends of the thermal firing resistors of a corresponding resistor group to power, the power providing a voltage greater than the low voltage.

2. The die of claim 1, wherein upon current being caused to pass through a given thermal firing resistor, the given thermal firing resistor is to cause a fluid droplet to be thermally ejected from a corresponding fluid-ejection nozzle of the fluid-ejection device.

3. The die of claim 1, wherein to cause current to be passed through a given thermal firing resistor, the low-side switch corresponding to the given thermal firing resistor is closed, and the high-side switch corresponding to the resistor group in which the given thermal firing resistor is located is closed.

4. The die of claim 1, wherein the low-side switches and the high-side switches are each left open except when fluid droplets are to be thermally ejected from the fluid-ejection device.

5. The die of claim 1, wherein a ratio of the thermal firing resistors to the resistor groups is at least substantially twelve to one.

6. A thermal drop-on-demand fluid-ejection device comprising:
one or more fluid supplies; and,
one or more dies to cause fluid droplets of the fluid supplies to be ejected from fluid-ejection device, each die comprising:
a plurality of thermal firing resistors organized over a plurality of resistor groups such that each thermal firing resistor is located within only one of the resistor groups, the resistor groups lesser in number than the thermal firing resistors, each thermal firing resistor having a first end and a second end;
a plurality of low-side switches equal in number to the thermal firing resistors, each low-side switch connecting the second end of a corresponding thermal firing resistor to a low voltage; and,
a plurality of high-side switches equal in number to the resistor groups, each high-side switch connecting the first ends of the thermal firing resistors of a corresponding resistor group to power, the power providing a voltage greater than the low voltage.

7. The fluid-ejection device of claim 6, wherein upon current being caused to pass through a given thermal firing resistor, the given thermal firing resistor is to cause a fluid droplet to be thermally ejected from a corresponding fluid-ejection nozzle of the fluid-ejection device.

8. The fluid-ejection device of claim 6, wherein to cause current to be passed through a given thermal firing resistor, the low-side switch corresponding to the given thermal firing resistor is closed, and the high-side switch corresponding to the resistor group in which the given thermal firing resistor is located is closed.

9. The fluid-ejection device of claim 6, wherein the low-side switches and the high-side switches are each left open except when fluid droplets are to be thermally ejected from the fluid-ejection device.

10. The fluid-ejection device of claim 6, wherein the dies are immovably disposed within an array laterally positioned over a width of a media sheet that is advanced longitudinally through the fluid-ejection device.

11. The fluid-ejection device of claim 6, further comprising a scanning printhead to move laterally across a media sheet as the media sheet is advanced longitudinally through the fluid-ejection device, the dies disposed within the scanning printhead.

12. A method comprising:
in response to determining that a fluid-ejection nozzle of a thermal drop-on-demand fluid-ejection device is to eject a fluid droplet on a media sheet,
(a) closing a low-side switch corresponding to a particular thermal firing resistor of a die of the fluid-ejection device, the particular thermal firing resistor corresponding to the fluid-ejection nozzle, the low-side switch individually connecting the particular thermal firing resistor to a low voltage;
(b) closing a high-side switch corresponding to a particular resistor group of thermal firing resistors, including the particular thermal firing resistor, of the die, the high-side switch connecting all the thermal firing resistors of the particular resistor group to power, the particular thermal firing resistor not being located in any resistor group other than the particular resistor group, the power providing a voltage greater than the low voltage,
wherein (a) and (b) are performed in an order comprising one of: (a) being performed prior to (b), (b) being performed prior to (a), and (a) and (b) being performed at least substantially simultaneously; and,
after the low-side switch and the high-side switch have been closed, opening the low-side switch and the high-side switch in an order comprising one of: opening the low-side switch before opening the high-side switch, opening the high-side switch before opening the low-side switch, and opening the low-side switch and the high-side switch at least substantially simultaneously.

13. The method of claim 12, wherein the low-side switch is opened after a period of time after the high-side switch is opened to at least substantially completely discharge any remaining charge.

14. The method of claim 12, wherein closing the low-side switch and the high-side switch causes current to pass through just the particular thermal firing resistor, and no other of the thermal firing resistors, such that the current passing through the particular thermal firing resistor causes the fluid droplet to be thermally ejected from fluid-ejection nozzle.

15. The method of claim 12, further comprising initially opening the low-side switch and the high-side switch, such that after the low-side switch and the high-side switch have been closed, the low-side switch and the high-side switch are reopened.
